(19) United States
(12) Patent Application Publication
(10) Pub. No.: US 2010/0110913 A1
(43) Pub. Date: May 6, 2010

(54) INTERFERENCE DETECTING DEVICE AND METHOD FOR DETECTING INTERFERENCE FOR WIRELESS COMMUNICATION

(75) Inventors: Sang Hyun Min, Yongin-Si (KR); Soon Jin Choi, Suwon-Si (KR); Jae Hyung Lee, Suwon-Si (KR); Sang Ho Lee, Suwon-Si (KR); Kwang Mook Lee, Suwon-Si (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon-Si (KR)

(21) Appl. No.: 12/347,846

(22) Filed: Dec. 31, 2008

(30) Foreign Application Priority Data
Oct. 31, 2008 (KR) 10-2008-0107900

(51) Int. Cl. H04L 12/26

(52) U.S. Cl. 370/252

(57) ABSTRACT

The present invention relates to a method for detecting interference and an interference detecting device for a wireless communication capable of improving detection accuracy of an interference signal in a wireless communication device without influencing network operation while the interference signal is detected; and, more particularly, to a method for detecting interference and an interference detecting device for a wireless communication to determine an interference signal by increasing an interference packet count according to an RSSI value, its own packet detection, gain reduction, deterioration of signal quality, the number of the same symbols, and so on and comparing an increased interference packet count value with a threshold value by using each ZigBee device as a main constituent of interference detection unlike a conventional method for detecting interference in which a ZigBee coordinator or a ZigBee router is a main constituent of interference detection.

### CROSS-REFERENCE TO RELATED APPLICATIONS

This application claims the benefit of Korean Patent Application No. 10-2008-0107900 filed with the Korea Intellectual Property Office on Oct. 31, 2008, the disclosure of which is incorporated herein by reference.

### BACKGROUND OF THE INVENTION

1. Field of the Invention

The present invention relates to a method for detecting interference and an interference detecting device for a wireless communication capable of improving detection accuracy of an interference signal in a wireless communication device without influencing network operation while the interference signal is detected; and, more particularly, to a method for detecting interference and an interference detecting device for a wireless communication to determine an interference signal by increasing an interference packet count according to an RSSI value, its own packet detection, gain reduction, deterioration of signal quality, the number of the same symbols, and so on and comparing an increased interference packet count value with a threshold value by using each ZigBee device as a main constituent of interference detection unlike a conventional method for detecting interference in which a ZigBee coordinator or a ZigBee router is a main constituent of interference detection.

2. Description of the Related Art

Nowadays, with the convenience of wireless communication technologies such as ZigBee communication and the development of these technologies, various wireless communication technologies have been used for the gradually increasing number of electronic devices. As the use of a wireless communication unlike a wire communication increases, there is a problem that radio interference is caused between wireless communication devices. Undoubtedly, most of the wireless communication technologies are managed not to be influenced by interference therebetween by dividing usable frequencies, however, since recently, in case of an ISM(Industrial, Scientific and Medical) frequency band around 2.4 GHz of which the use is more rapidly growing, a lot of wireless technologies employ the same frequency band, a radio interference problem has come to assume a grave aspect. Therefore, development of a technology to solve the radio interference problem among the wireless technologies using the ISM frequency band is urgently needed.

Although various technologies, which can minimize influence of radio interference between a WLAN(Wireless Local Area Network) and a BT(Bit Torrent) as currently commercialized representative technologies, have been already developed and applied to a product, few commercial technologies to minimize radio interference among the other wireless technologies have been developed.

Therefore, in order to effectively avoid or minimize the radio interference among these devices, information whether the radio interference is generated or to be generated is required and methods for dividing usable times or usable frequencies among the devices and so on based on the information are used to minimize the interference.

FIG. 1a to FIG. 1c views showing situations where interference is generated between a WLAN as a representative ISM band wireless device and a ZigBee communication with a) a frequency according to a time, b) a space(received power) according to a time and c) ZB(ZigBee) device 10 and a WLA device 20.

In case that its own system is influenced by the interference, usable frequencies of an interferometer and the its own system are partially matched in a time zone when a packet is transmitted and received power of an interference signal is introduced higher than that of its own signal. That is, as shown in FIG. 1a, ZB data 10′ and WLAN data 20′ employ the same frequency channel 1 in the same time zone and as shown in FIG. 1b, higher received power is introduced to the WLAN data 20′ in comparison with the ZB data 10′ at a frequency of 2.4 GHz. Due to the interference, its own system is influenced, e.g. communication speed is deteriorated or packet reception is reduced.

FIG. 2a is a view illustrating a simple network construction related to a method for detecting whether interference is generated or not in accordance with the prior art and FIG. 2b is a flow chart showing an algorithm for detecting the interference.

As shown in FIG. 2a, a ZC(ZigBee Coordinator) 12 plays a role of a network administrator and has the authority to change a usable frequency. And, a ZR(ZigBee Router) 12 plays a role of transmitting data for a smooth data communication among a plurality of remote wireless terminals. A ZE(ZigBee End-Device) 11 is a device for communicating with the ZC or different ZEs as individual wireless terminal devices. A ZE1 represents a situation where the ZE is influenced by the interference by the WLAN device.

Hereinafter, a method for detecting interference in accordance with the prior art will be described with reference to FIG. 2b. The ZCs or ZRs on network are main constituents of interference detection. These continuously count the total number of packet transmission and the number of failures of the packet transmission and primarily determine that the interference is generated if the total number of the packet transmission is more than 20 and the number of failures of the packet transmission among the total number of the packet transmission exceeds approximately 25% at step S20.

In a situation shown in FIG. 2a, the ZR1 primarily checks that the interference is generated at step S21. Thereafter, in order to check that the interference is practically generated, the ZR1 secondarily performs active scan for all frequency channels to observe an energy level of a corresponding channel for a predetermined time and compares whether an energy level of a current used channel is higher than those of other channels or not at step S22.

If the energy level of the currently used frequency channel is not higher than those of other channels, since the channel is clean, it is determined that the interference is not generated and operation is returned to a normal operation state(in case of No at step S22). However, if the energy level of the currently used frequency channel is higher than those of other channels, it is finally determined that the interference is generated and so the generation of the interference is notified to the network administrator ZC in order to reset values obtained by counting the number of its own packet transmission and the number of failures of its own packet transmission at step S23. If the network administrator receives this message, it determines whether to be transferred to a more clean frequency channel to match with a state of the network in order to change a usable frequency of the whole network.

The method for detecting the interference according to the prior art has the following problems.

First, there frequently occur cases where the absence of the interference is wrongly determined as the presence of the interference in primarily detecting the interference, which may affect normal network operation. In the conventional method, if the communication is not smoothly executed, it is determined that the inference is generated as a result of primarily detecting the interference, however, since a wireless communication channel environment is very variously changed according to positions among the communication devices and a change of a surrounding environment, there may occur many cases where the communication is not smoothly executed in real situation occasionally. And, although in case that a plurality of devices such as a ZigBee communicate in adjacent spaces through the same channel, an anti-collision algorithm has been applied, there still occur cases where they fail in the communication due to message collision among the ZigBee devices and therefore if the cases of failures in the communication due to such various factors are wrongly judged as case whether the interference is generated every time, too many interference tests should be performed, which may affect the normal network operation since the corresponding ZC or ZR should perform the interference tests.

Second, in a secondary interference test, the energy levels are compared by performing the active scan for all the channels, wherein since the active scan should be performed for a sufficient time for all the channels or a plurality of channels, the normal network operation can not be executed for the time, whereby the conventional method can cause a very fatal error according to the application thereof.

Third, in case that the interferometer transmits many signals in the primary interference test but it does not transmit any data in the secondary interference test, since the interference is not detected although the active scan is performed for a predetermined time for its own channel, it can be wrongly determined that the interference is not generated. Thereafter, if the communication is executed again, there can occur a case where the device is damaged due to the interference. Practically, in case of the use of the wireless Internet using the WLAN device as a practically representative interferometer, e.g., an Internet use pattern, a mass of data is transmitted when opening a new page but any data is not transmitted and only a very short beacon signal is periodically transmitted when a user sees a single screen. So, in such a case, it is not easy to detect the inference satisfactorily even though the active scan is executed. In order to compensate this problem, the active scan is performed for a very long time, which may affect the normal network operation as described above.

Lastly, in a situation shown in FIG. 2a, a device practically damaged by the interference is the ZE1 and a device detecting the interference is the ZR1 and so there is a problem that a practical interference situation is not exactly measured. When the ZE1 receives data transmitted from the ZR1, it can not smoothly receive the data due to an interference signal. However, in case that while the interference signal reaches the ZE1, attenuation is not large and so the ZE is influenced by the interference signal but while it reaches the ZR1, the attenuation is very intense and so the ZR1 is hardly influenced by the interference signal, the interference is determined to be generated in the ZR1 and the active scan is performed but an energy level is very low, which leads to a case where the interference is not detected.

Therefore, an effective method for detecting the radio interference is required as a major function to minimize the radio interference between an IEEE 802.15.4 wireless device well-known as the ZigBee and other wireless devices such as the WLAN, the BT, a DECT(Digital Enhanced Cordless Telecommunications) and a non-standard technology is required.

### SUMMARY OF THE INVENTION

The present invention has been invented in order to overcome the above-described problems and it is, therefore, an object of the present invention to provide a method for detecting interference and an interference detecting device for a wireless communication to determine an interference signal by increasing an interference packet count according to an RSSI value, its own packet detection, gain reduction, deterioration of signal quality, the number of the same symbols, and so on and comparing an increased interference packet count value with a threshold value by using each ZigBee device as a main constituent of interference detection unlike a conventional method for detecting interference in which a ZigBee coordinator or a ZigBee Router is a main constituent of interference detection in order to minimize radio interference between an IEEE 802.15.4 wireless device well-known as a ZigBee and other wireless devices such as a WLAN(Wireless Local Area Network), a BT(Bit Torrent), a DECT(Digital Enhanced Cordless Telecommunications) and a non-standard technology.

In accordance with one aspect of the present invention to achieve the object, there is provided a method for detecting interference for a wireless communication including the steps of: A) increasing a time count until a preset interference detection determination time if a signal is received by a wireless communication device; B) during the interference detection determination time, b1) comparing an RSSI value of the received signal with a preset RSSI threshold value; b2) if the RSSI value of the received signal is larger than the RSSI threshold value, detecting its own packet signal from the received signal in order to discriminate a data signal from an interference signal; b3) if said its own packet signal is detected in the step of b2), determining whether a gain of the received signal is reduced or not; b4) if the gain is reduced in the step of b3), determining whether quality of the received signal is deteriorated or not; b5) if the quality of the received signal is deteriorated in the step of b4), testing symbols of the received signal; and b6) if the number of the same symbols is less than a preset threshold value in the step of b5), increasing an interference packet count; C) comparing a preset interference packet count threshold value with the interference packet count after the interference detection determination time; and D) if the interference packet count is larger than the interference packet count threshold value, determining the signal as the interference signal.

Further, it is preferable that the method further includes the steps of: E) reporting the determination as the interference signal to an MAC(Medium Access Control); and F) resetting the time count and the interference packet count.

Further, it is preferable that if a normal wireless signal is received, the RSSI threshold value is updated with an RSSI value of the normal signal.

Further, it is preferable that if the RSSI value of the received signal is smaller than the RSSI threshold value in the step of b1, the method further includes the step of; resetting the time count.

Further, it is preferable that in the step of b2), whether a ZigBee packet is introduced or not is tested through whether an SFD(Start of Frame Delimiter) signal is generated or not.

Further, it is preferable that if said its own packet signal is not detected in the step of b2) and the increased time count is larger than the preset time count threshold value, the method further includes the step of: increasing the interference packet count.

Further, it is preferable that if the increased time count is smaller than the preset time count threshold value, the method further includes the steps of: resetting the time count.

Further, it is preferable that if the gain is not reduced in the step of b3), the method further includes the step of: resetting the time count.

Further, it is preferable that if the quality of the signal is not deteriorated in the step of b4), the method further includes the step of: resetting the time count.

Further, it is preferable that if the number of the same symbols is larger than the preset threshold value in the step of b5), the method further includes the step of: resetting the time count.

Meanwhile, in accordance with another aspect of the present invention to achieve the object, there is provided an interference detecting device for a wireless communication including: an RSSI(Received Signal Strength Indication) testing unit for comparing an RSSI value of a signal received by a wireless communication device with a preset RSSI threshold value; a time count unit for counting a time and comparing a time count value with a preset time threshold value; and an interference generation testing unit for counting an interference packet and comparing an interference packet count value after a preset period with a preset interference packet threshold value, wherein the RSSI testing unit resets a time count if the RSSI value of the received signal is smaller than the RSSI threshold value and operates the time count unit in order to increase the time count value if the RSSI value of the received signal is larger that the RSSI threshold value, the time count unit operates the interference generation testing unit in order to increase the interference packet count value if the time count value is larger than the time threshold value, and the interference generation testing unit determines that the interference is generated if the interference packet count value is larger than the interference packet threshold value.

Further, it is preferable that if a normal wireless signal is received, the RSSI testing unit updates the RSSI threshold value with an RSSI value of the normal wireless signal.

Further, it is preferable that the interference detecting device further includes its own packet testing unit for detecting whether the normal wireless signal is received or not.

Further, it is preferable that said its own packet testing unit tests whether a ZigBee packet is introduced or not through whether an SFD(Start of Frame Delimiter) signal is generated or not.

Further, it is preferable that if said its own packet testing unit determines that the normal signal is received, said its own packet testing unit resets the time count unit, stops the time count unit until the receiving of the signal is finished and hereafter, operates the time count again.

Further, it is preferable that the interference detecting device for the wireless communication further includes a quality change testing unit for testing whether a gain is reduced to less than a preset threshold value or signal quality is reduced to less than a preset threshold value while the normal signal is received; and a symbol testing unit for counting the number of the same symbols among received symbols and comparing the number of the same symbols with a preset threshold value while the normal signal is received.

It is preferable that if the counted number of the same symbols is smaller than the preset threshold value, the symbol testing unit operates the interference generation testing unit in order to increase the interference packet count.

Further, it is preferable that if the interference is generated, the interference generation testing unit reports the generation of the interference to an MAC(Medium Access Control) of the wireless communication device.

Further, it is preferable that the interference generation testing unit resets the interference packet count value after the preset period.

Further, it is preferable that if the time count value is smaller than the time threshold value, the time count unit resets the time count value.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1a to FIG. 1c views showing cases of a) a frequency channel, b) power and c) collision of data between a ZigBee device and a WLAN device;

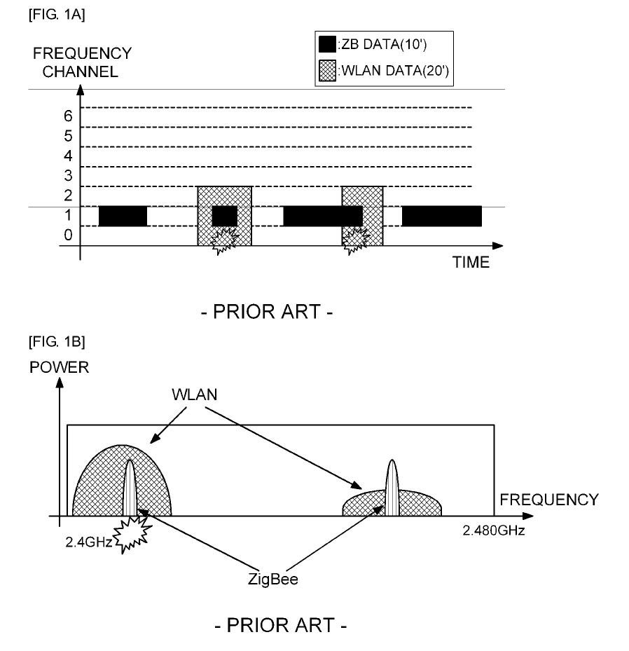

FIG. 2a is a view illustrating a case where data collision is generated between a ZigBee device and a WLAN device and FIG. 2b is a flow chart showing a method for detecting interference of the ZigBee device in accordance with the prior art;

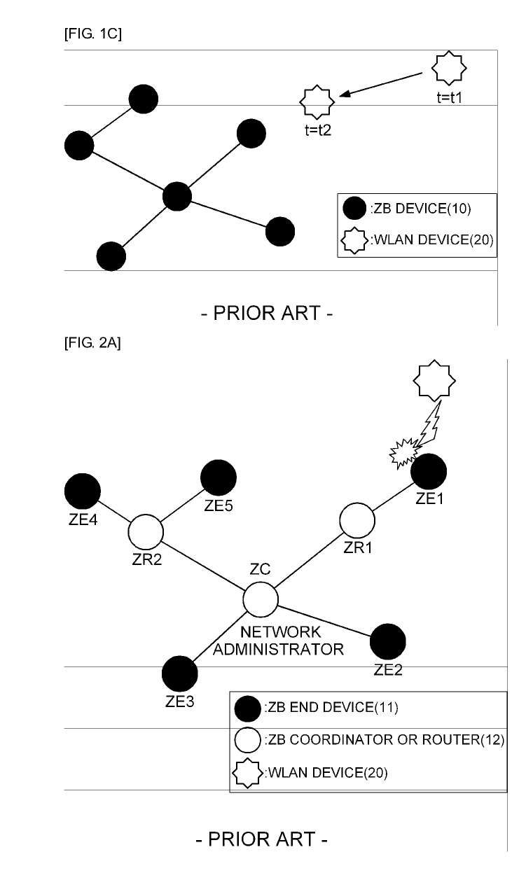

FIG. 3 is a flow chart showing a method for detecting interference for a wireless communication in accordance with one embodiment of the present invention;

FIG. 4a to FIG. 4c are views depicting shapes of signals detected by a method and an interference detecting device for a wireless communication in accordance with the present invention and FIG. 4d is a view showing shapes of signals not detected by the method and the interference detecting device for the wireless communication in accordance with the present invention;

FIG. 5 is a block diagram of a wireless communication device including an interference detecting device in accordance with one embodiment of the present invention; and

FIG. 6 is an internal block diagram of the interference detecting device for a wireless communication in accordance with one embodiment of the present invention.

### DETAILED DESCRIPTION OF THE PREFERABLE EMBODIMENTS

Hereinafter, a matter regarding to an operation effect including a technical configuration corresponding to an object of a method for detecting interference and an interference detecting device for a wireless communication in accordance with the present invention will be appreciated clearly through the following detailed description with reference to the accompanying drawings illustrating preferable embodiments of the present invention.

First of all, the following abbreviations stand for the following meanings.

RF(Radio Frequency)

RSSI(Received Signal Strength Indication)

MAC(Medium Access Control)

SFD(Start of Frame Delimiter)

AGC(Automatic Gain Controller)

The present invention proposes a new method capable of improving accuracy of interference detection without affecting network operation while detecting interference, which is pointed out as a problem to be solved in the description of the Related Art. The conventional method employs a methodology at an NWK(network) level to detect the interference, whereas the present invention employs a methodology at a PHY level(RF& modem) to detect the interference. An object of the present method is to effectively detect the interference by adding an interference detecting device for detecting the interference which is simple in hardware.

Method for Detecting Interference for a Wireless Communication

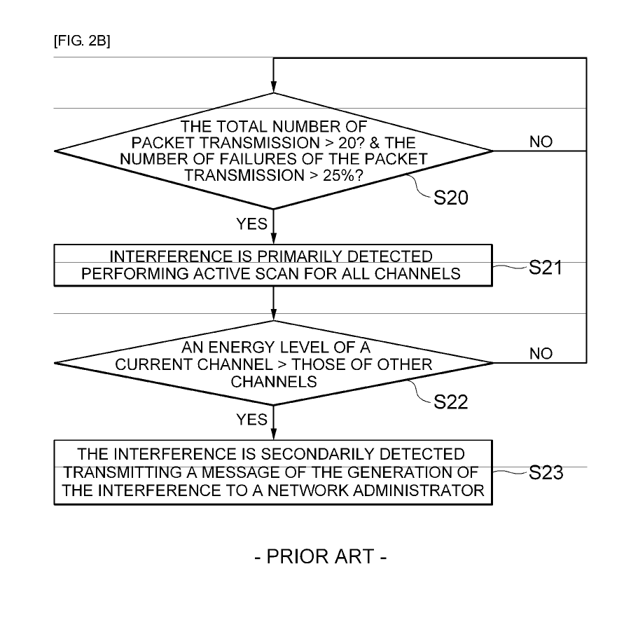

FIG. 3 is an operation flow chart showing a method for detecting interference in accordance with one embodiment of the present invention.

As shown in FIG. 3, an interference detecting device receives an RSSI value from an RSSI sensor, an SFD detection signal from a modem and a current signal quality value and collectively observes these values in order to determine whether the interference is generated or not. If the interference detecting device determines generation of the interference, it notifies an MAC/NWK layer of the generation of the interference. Unlike the prior art, the present invention can detect the interference while all ZigBee devices(ZC,ZR,ZE) operate in a received mode and the interference detecting device reports whether the interference is generated to a network administrator so that the network administrator performs a proper method for avoiding the interference. Further, the interference detecting device operates independently of data acquisition in the received mode and so it does not have any influence on a wireless device to perform data communication.

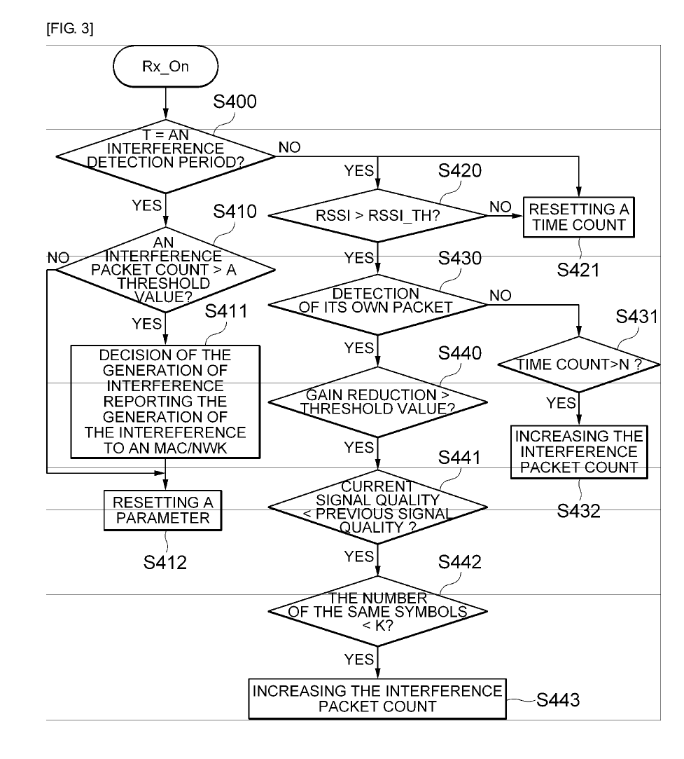

Hereinafter, the method for detecting the interference in each case shown in FIGS. 4a) to 4d) will be described with reference to the flow chart shown in FIG. 3.

The interference detecting device determines the generation of the interference by using the RSSI value, a gain changed value and a parameter value inside the modem. The interference detecting device performs an operation while the wireless device is in a received mode state, detects three interference situations shown in FIGS. 4a) to 4c) and does not detect a case where ZigBee packets collide with each other as show in FIG. 4d) as the interference.

a) Detection Method in Case that Only an Interference Signal Exists

FIG. 4a illustrates a case where an interference signal is received at received signal strength higher than an RSSI threshold value for a time longer than a threshold value of a packet length.

The RSSI value is a value corresponding to power of an internal signal and is updated with an average value for a predetermined time(in case of ZigBee, 128 us) every time. A time count is increased until a preset time when interference detection is detected if a signal is received by a wireless communication device at step S400. An RSSI comparator of the interference detecting device determines whether an RSSI value of the received signal exceeds an RSSI threshold value RSSI_TH at step S420. A time count value is reset for a moment when a current RSSI value falls below the threshold value at step S421. In other words, it is determined that the signal is not an interference signal. Practically, even the interference signal, if the RSSI value is less than the threshold value, it does not influence the wireless communication device.

After determining whether the RSSI value of the received signal exceeds the RSSI threshold value RSSI TH at step S420, if the RSSI value exceeds the threshold value, it is determined whether its own packet is introduced at step S430 by checking whether a signal(in case of ZigBee, an SFD signal), which indicates that its own packet is detected in a modem, is generated.

A time counter counts a time in order to roughly measure a packet length from the moment when the RSSI value exceeds the threshold value at step S431. Even when its own packet is detected(in case of YES at step S430), the time count value is reset.

If the time count value is not reset, i.e., its own packet signal is not detected and the packet length is larger than a packet length threshold value LENGTH_TH at step S431, it is determined that the signal is the interference signal and so an interference packet count value is increased at step S432. At this time, it is waited until the RSSI value falls below the threshold value(packet transmission is finished) without further increasing the time count.

Meanwhile, the RSSI threshold value is designed to have hysteresis and is not an arbitrary fixed value but a value obtained by updating the RSSI threshold value with an RSSI value when receiving a normal ZigBee packet every time.

b) Detection Method in Case that an Interference Signal and a ZigBee Signal Collide with Each Other

In case that an interference signal and a ZigBee signal collide with each other 500, since any its own packet data can not be detected due to the interference signal, in a position of a wireless communication device, it is the same as the case where only the interference signal exists as shown in FIG. 4a and therefore a detection method thereof is also the same.

c) Detection Method in Case that a ZigBee Signal and an Interference Signal Collide with Each Other

As shown in FIG. 4c), since the ZigBee signal is first detected at step S430, a time count value is reset as 0 and the time count value is not increased until packet transmission is finished. In case like this that a ZigBee packet is detected, instantaneous gain values, parameter values corresponding to signal quality and detected symbol values are collectively observed from a modem and an AGC block.

In case that a gain falls at more than a predetermined size while receiving packet data, i.e., received signal power is larger at more than a predetermined size, when received power of its own signal increases, since a signal to noise ratio is improved, signal quality may be equal to or better than previous signal quality. However, if an interference signal with larger received power is introduced, although the received power increases, the signal quality may be sharply deteriorated.

Therefore, if the gain reduces at more than the predetermined size while receiving the packet data(although the received power increases) at step S440, generation of the interference is detected by checking whether the signal quality is sharply reduced in comparison with previous signal quality at step S441.

Meanwhile, as shown in FIG. 4d), even in collision between the ZigBee signals, the deterioration of the signal quality can be caused, wherein in case that the interference signal is introduced, symbol data detected around an interference generation time(when the signal power is increased at more than the predetermined size) may be detected as different arbitrary data. Accordingly, if as a result of observing a detected symbol value, the number of the same symbols is above a threshold value number at step S442, it is determined that the signal is an interference signal and so an interference packet count is increased at step S443.

Since the case where the packet collision between its own communication devices is not generated like ZigBee can be the case where the situation shown in FIG. 4d) is not generated, it is possible to detect whether the interference is generated or not by observing only a change of the received power and the signal quality.

d) Detection Method in Case that a ZigBee Signal and a ZigBee Signal Collide with Each Other

In this case, like the case shown in FIG. 4c), while receiving a ZigBee packet, although signal power is increased, signal quality is sharply deteriorated at step S441. However, in case of collision between ZigBee packets, since 4byte of symbol ‘0’ is included at a start portion of a packet which collides later and interferes for synchronization acquisition, the symbol data are plurally detected around an interference generation time as the same symbols due to this portion.

Therefore, if as a result of observing 8 symbol values detected around the interference generation time, the number of the same symbols is above a threshold value number, it is determined as the collision between the ZigBee signal and the ZigBee signal and so an interference packet count is not increased(in case of No at step at step S442).

In cases shown in FIGS. 4a) to 4c), the interference packet count is increased. Thereafter, after an interference detection determination time(several tens of ms˜several hundreds of ms), the interference packet count detected by the above-mentioned method for detecting the interference is compared with an interference packet threshold value at step S410. The interference packet count is larger than the threshold value, it is finally determined that the interference is generated and so information of the generation of the interference is reported and informed to superordinate MAC/NWK at step S411. If the interference packet count is smaller than the threshold value, it is determined that the interference is not generated. Since the generation of the interference is finally determined by observing an interference generation degree for the predetermined time, practically, in only the case where the interference generation degree is serious, an interference generation message is informed, which does not affect network operation. When the interference detection determination time comes, all count values and parameter values are reset in order to perform the interference detection again at step S412. When MAC/NWK of an individual communication device receives the information of the generation of the interference, it sends an interference generation message to a network administrator ZC on network so that the network administrator performs a proper method for avoiding the interference.

Interference Detecting Device for a Wireless Communication

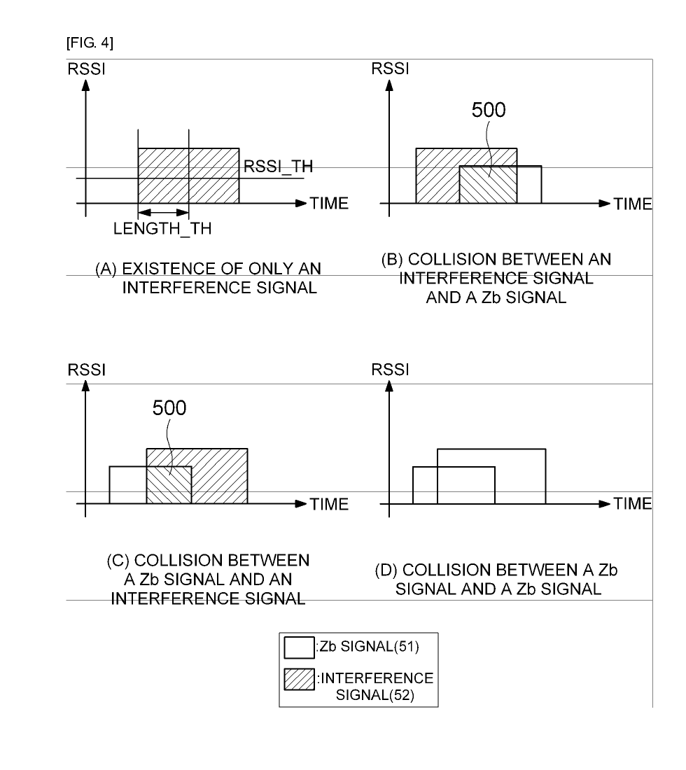

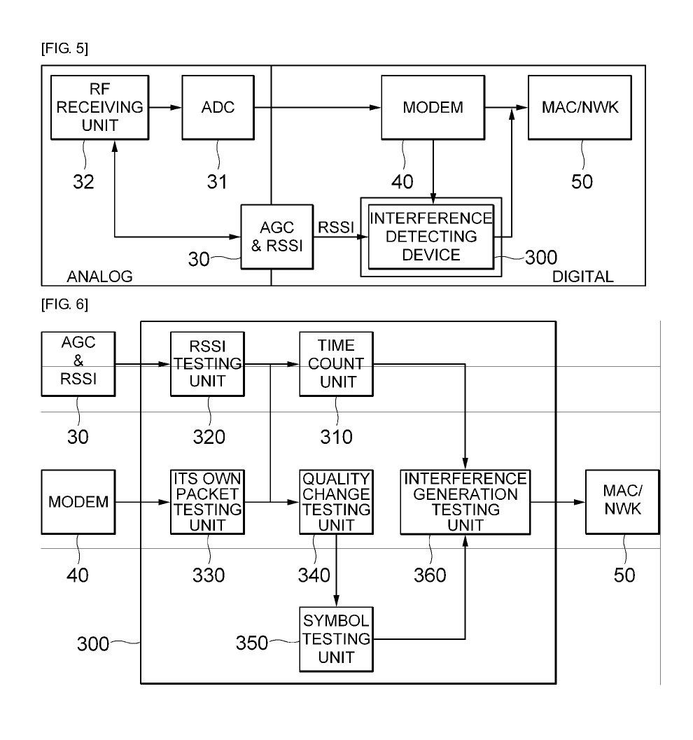

FIG. 5 is a block diagram illustrating a wireless communication device including an interference detecting device by dividing the wireless communication device into an analog part and a digital part in accordance with one embodiment of the present invention. Further, FIG. 6 is an internal block diagram of the interference detecting device for a wireless communication in accordance with the one embodiment of the present invention.

The analog part of the wireless communication device includes an RF receiving unit 32 for receiving a wireless signal and an ADC(Analog-Digital Converter) 31 for converting an analog signal into a digital signal. And, the digital part includes an AGC and RSSI unit 30, a modem 40 and an MAC/NWK 50. Herein, the digital part further includes the interference detecting device 300 in accordance with the present invention.

It is preferable that the interference detecting device 300 for the wireless communication in accordance with one embodiment of the present invention includes a time count unit 310, an RSSI testing unit 320, its own packet testing unit 330, a quality change testing unit 340, a symbol testing unit 350 and an interference generation testing unit 360.

The RSSI testing unit 320 receives an RSSI value of a signal received by the wireless communication device through the AGC and RSSI unit 30. Thereafter, a preset RSSI threshold value and the RSSI value of the received signal are compared. If the RSSI value of the received signal is smaller than the RSSI threshold value, a time count is reset and if the RSSI value of the received signal is larger than the RSSI threshold value, the time count unit 310 is operated in order to increase a time count value. In other words, if the RSSI value is smaller than the RSSI threshold value, in spite of an interference signal, it is determined that the signal has little influence on the wireless communication device. Further, if the RSSI value is larger than the threshold value, whether the signal is the interference signal or its own packet signal is determined while increasing the time count.

Meanwhile, it is preferable that if the RSSI testing unit 320 receives a normal wireless signal, it updates the RSSI threshold value with an RSSI value of the normal wireless signal in order to reflect hysteresis of the RRSI value of the received signal not determine the interference signal with a fixed RSSI threshold value.

The time count unit 310 counts a time and compares a time count value and a preset time threshold value. If the time count value is larger than the time threshold value, the interference generation testing unit 360 is operated in order to increase an interference packet count value and if the time count value is smaller than the time threshold value, the time count value is reset.

The interference generation testing unit 360 counts an interference packet and compares an interference packet count value after a preset period with a preset interference packet threshold value. If the interference packet count value is larger than the interference packet threshold value, it is determined that interference is generated and so the generation of the interference is reported to the MAC/NWK 50 of the wireless communication device. The case where the interference packet count value is smaller than the threshold value is determined as the absence of the interference. This case is determined not to influence the wireless communication device in order to exclude the case where the wireless communication device is influenced by generation of trivial interference. Meanwhile, it is preferable that the interference packet count value of the interference generation testing unit 360 is reset after the preset period.

If the RSSI testing unit 320 determines that the RSSI value is larger than the threshold value, it is necessary to test whether the normal wireless signal is received or not. For this, the interference detecting device 300 includes said its own packet testing unit 330. Said its own packet testing unit 330 detects whether its own packet is introduced or through whether a specific signal is generated or not. In case of ZigBee communication, whether a ZigBee packet is introduced can be detected through whether an SFD(Start of Frame Delimiter) signal is generated or not. In other words, if the SFD is detected from the received signal, it is determined that the received signal is its own packet signal not an interference signal. It is preferable that if said its own packet testing unit 330 determines that the normal signal is received, it resets the time count unit 310, stops the time count unit 310 until the receiving of the signal is finished and after the receiving is finished, operates the time count unit 310 again.

However, even while its own packet signal is received, the case shown in FIG. 4c) or FIG. 4d) where the interference signal or the same its own packet signal is repeatedly received can be caused. For this, it is preferable to further include the quality change testing unit 340 and the symbol testing unit 350.

The quality change testing unit 340 tests whether a gain is reduced to less than a preset threshold value or whether signal quality is reduced to less than a preset threshold value while the normal signal is received. The symbol testing unit 350 counts the number of the same symbols among symbols received while the normal signal is received and compares the number of the same symbols with a preset threshold value.

Even though the normal signal is received, in case that thereafter, the interference signal is received or the normal signal is received again, the gain is reduced and the signal quality is reduced. Therefore, in case that the signal quality is changed, the numbers of symbols are compared. In case that the same signals are repeatedly received, the number of the same symbols may be larger than the threshold value. However, in case of the interference signal, the number of the same symbols may be below the threshold value. Therefore, if the counted number of the same symbols is smaller than the preset threshold value, the symbol testing unit 360 operates the interference generation testing unit 360 in order to increase an interference packet count. Therefore, unlike the conventional interference detecting device for detecting only the case shown in FIG. 4a), the interference detecting device in accordance with the present invention can detect all the cases shown in FIGS. 4a) to 4d).

The interference detecting device and the method for detecting the interference using the same in accordance with the present invention have the following improved effects for the problems pointed out in the conventional method.

First, the conventional method determines that a failure of communication is caused by only interference although the failure of communication is caused by several factors such as fading, message collision between the ZBs and interference and performs additional tests, which leads to much wrong determination, thereby influencing the network operation, whereas the present invention detects the interference only for the case where an interference packet practically exists or it is influenced by the interference packet and therefore it is possible to more exactly detect the interference.

Second, the conventional method performs active scan for all channels in secondary interference detection after primary interference detection, which can influence the network operation, whereas the present invention can detect the interference without influencing the network operation.

Third, in the conventional method, the interference can not be detected well in secondary active scan after the primary interference detection, whereas the present detects the interference as soon as an interference signal exists or damage is caused due to the interference and therefore it is possible to exactly detect the interference even when WLAN Internet is used.

Lastly, the conventional method has a problem that since the interference is detected by the ZigBee adjustor or the ZigBee router adjacent to a device damaged by the interference instead of the device damaged by the interference, the interference is not detected satisfactorily in the active scan, whereas the present invention can implement exact detection of the interference by detecting the interference by all devices damaged by the interference.

As described above, in accordance with the present invention, the method for detecting the interference and the interference detecting device for the wireless communication have the following advantages. First, it is possible to more exactly detect the interference by detecting the interference only for the case where the interference packet practically exists or it is influenced by the interference packet. Second, it is possible to detect the interference without influencing the network operation since the active scan is not performed. Third, it is possible to exactly detect the interference even when the WLAN Internet is used by detecting the interference as soon as the interference signal exists or the damage is caused due to the interference. Lastly, it is possible to implement the exact detection of the interference by detecting the interference by all the devices damaged by the interference.

As described above, although the preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

1. A method for detecting interference for a wireless communication comprising the steps of:
A) increasing a time count until a preset interference detection determination time if a signal is received by a wireless communication device;
B) during the interference detection determination time,
b1) comparing an RSSI(Received Signal Strength Indication) value of the received signal with a preset RSSI threshold value;
b2) if the RSSI value of the received signal is larger than the RSSI threshold value, detecting its own packet signal from the received signal in order to discriminate a data signal from an interference signal;
b3) if said its own packet signal is detected in the step of b2), determining whether a gain of the received signal is reduced or not;
b4) if the gain is reduced in the step of b3), determining whether quality of the received signal is deteriorated or not;
b5) if the quality of the received signal is deteriorated in the step of b4), testing symbols of the received signal; and
b6) if the number of the same symbols is less than a preset threshold value in the step of b5), increasing an interference packet count;
C) comparing a preset interference packet count threshold value with the interference packet count after the interference detection determination time; and
D) if the interference packet count is larger than the interference packet count threshold value, determining the signal as the interference signal.

2. The method of claim 1, further comprising the steps of:
E) reporting the determination as the interference signal to an MAC(Medium Access Control); and
F) resetting the time count and the interference packet count.

3. The method of claim 1, wherein if a normal wireless signal is received, the RSSI threshold value is updated with an RSSI value of the normal signal.

4. The method of claim 1, wherein if the RSSI value of the received signal is smaller than the RSSI threshold value in the step of b1, further comprising the step of;
resetting the time count.

5. The method of claim 1, wherein in the step of b2), whether said its own packet signal is detected or not is tested through whether an SFD(Start of Frame Delimiter) signal is generated or not.

6. The method of claim 1, wherein if said its own packet signal is not detected in the step of b2) and the increased time count is larger than the preset time count threshold value, further comprising the step of:
increasing the interference packet count.

7. The method of claim 6, wherein if the increased time count is smaller than the preset time count threshold value, further comprising the steps of:
resetting the time count.

8. The method of claim 1, wherein if the gain is not reduced in the step of b3), further comprising the step of:
resetting the time count.

9. The method of claim 1, wherein if the quality of the signal is not deteriorated in the step of b4), further comprising the step of:
resetting the time count.

10. The method of claim 1, wherein if the number of the same symbols is larger than the preset threshold value in the step of b5), further comprising the step of:
resetting the time count.

11. An interference detecting device for a wireless communication comprising:
an RSSI(Received Signal Strength Indication) testing unit for comparing an RSSI value of a signal received by a wireless communication device with a preset RSSI threshold value;
a time count unit for counting a time and comparing a time count value with a preset time threshold value; and
an interference generation testing unit for counting an interference packet and comparing an interference packet count value after a preset period with a preset interference packet threshold value,
wherein the RSSI testing unit resets a time count if the RSSI value of the received signal is smaller than the RSSI threshold value and operates the time count unit in order to increase the time count value if the RSSI value of the received signal is larger than the RSSI threshold value,
the time count unit operates the interference generation testing unit in order to increase the interference packet count value if the time count value is larger than the time threshold value, and
the interference generation testing unit determines that the interference is generated if the interference packet count value is larger than the interference packet threshold value.

12. The interference detecting device for the wireless communication of claim 11, wherein if a normal wireless signal is received, the RSSI testing unit updates the RSSI threshold value with an RSSI value of the normal wireless signal.

13. The interference detecting device for the wireless communication of claim 11, further comprising:
its own packet testing unit for detecting whether its own packet signal is received or not.

14. The interference detecting device for the wireless communication of claim 13, wherein said its own packet testing unit tests whether said its own packet signal is received or not through whether an SFD(Start of Frame Delimiter) signal is generated or not.

15. The interference detecting device for the wireless communication of claim 14, wherein if said its own packet testing unit determines that the said its own packet signal is received, said its own packet testing unit resets the time count unit, stops the time count unit until the receiving of the signal is finished and hereafter, operates the time count again.

16. The interference detecting device for the wireless communication of claim 11, further comprising:
a quality change testing unit for testing whether a gain is reduced to less than a preset threshold value or signal quality is reduced to less than a preset threshold value while said its own packet signal is received; and
a symbol testing unit for counting the number of the same symbols among received symbols and comparing the number of the same symbols with a preset threshold value while said its own packet signal is received.

17. The interference detecting device for the wireless communication of claim 16, wherein if the counted number of the same symbols is smaller than the preset threshold value, the symbol testing unit operates the interference generation testing unit in order to increase the interference packet count.

18. The interference detecting device for the wireless communication of claim 11, wherein if the interference is generated, the interference generation testing unit reports the generation of the interference to an MAC(Medium Access Control) of the wireless communication device.

19. The interference detecting device for the wireless communication of claim 11, wherein the interference generation testing unit resets the interference packet count value after the preset period.

20. The interference detecting device for the wireless communication of claim 11, wherein if the time count value is smaller than the time threshold value, the time count unit resets the time count value.
